(19) United States
(12) Patent Application Publication
(10) Pub. No.: US 2026/0362154 A1
(43) Pub. Date: Nov. 12, 2026

(54) RADIO ZONE DESIGN SUPPORT APPARATUS, RADIO ZONE DESIGN SUPPORT METHOD AND PROGRAM

(71) Applicant: NTT, Inc., Tokyo (JP)

(72) Inventors: Daisuke MURAYAMA, Tokyo (JP); Toshiro NAKAHIRA, Tokyo (JP); So TAKATANI, Tokyo (JP); Takatsune MORIYAMA, Tokyo (JP)

(21) Appl. No.: 19/129,886

(22) PCT Filed: Jan. 13, 2023
(86) PCT No.: PCT/JP2023/000854

§ 371 Date: May 14, 2025

(51) Int. Cl. H04W 16/18; H04B 7/155; H04W 72/54

(52) U.S. Cl. CPC H04W 16/18; H04B 7/15571; H04W 72/54

(57) ABSTRACT

A radio zone design support apparatus includes circuitry to select one or more of a plurality of first patterns as second patterns based on a first value of an index related to predetermined communication quality that is different for each of the plurality of first patterns in a predetermined area; extract one or more candidates from among candidates for an arrangement position of one or more relay stations, for each of the second patterns; and select one or more of a plurality of third patterns based on a second value of an index related to predetermined communication quality that is different for each of the plurality of third patterns in the predetermined area, each of the plurality of third patterns being related to an arrangement state of the one or more relay stations with respect to the one or more candidates for each of the second patterns.

### TECHNICAL FIELD

The present invention relates to a station placement design support device, a station placement design support method, and a program.

### BACKGROUND ART

In order to construct a coverage area of a wireless system such as 5G or Wi-Fi (registered trademark), a station placement design for determining a base station arrangement (placement location or antenna direction) is performed. In the station placement design, a service area is sometimes simulated after a base station arrangement is selected, and estimation using an experimental formula (Non-patent Literature 1) or the like is used.

### CITATION LIST

### Non-Patent Literature

Non-patent Literature 1: Station Placement Design in Mobile Communication)”, NTT DOCOMO Technical Journal (Vol. 2, No. 4), [online], Internet <URL:https://www.nttdocomo.co.jp/binary/pdf/corporate/technology/rd/technical_journal/bn/vol2_4/vol2_4_035jp.pdf>

### SUMMARY OF INVENTION

### Technical Problem

A relay station that relays wireless communication between a base station and a terminal is disposed in a case where it is difficult to cover a target area only with the base station.

Conventionally, a method has not been provided in which an arrangement state (positions and directions) of a base station and a relay station is selected at high speed while considering communication quality, in a case where a wireless area is formed by combining the base station and the relay station.

The present invention has been made in view of the above points, and an object of the present invention is to enable selection of an arrangement state of a base station and a relay station at high speed while considering communication quality.

### Solution to Problem

Therefore, in order to solve the above problem, a station placement design support device includes: a first selection unit configured to select some of first patterns as second patterns on the basis of a value of an index related to predetermined communication quality in a predetermined area of each of a plurality of first patterns related to an arrangement state of one or more base stations; an extraction unit configured to extract some candidates from among candidates for an arrangement position of one or more relay stations for each of the second patterns; and a second selection unit configured to select some of third patterns as fourth patterns on the basis of a value of an index related to predetermined communication quality in the predetermined area of each of a plurality of third patterns related to an arrangement state of one or more relay stations with respect to the some candidates for each of the second patterns.

### Advantageous Effects of Invention

It is possible to select an arrangement state of a base station and a relay station at high speed while considering communication quality.

### BRIEF DESCRIPTION OF DRAWINGS

FIG. 1 is a diagram illustrating a system configuration example according to an embodiment of the present invention.

FIG. 2 is a diagram illustrating a hardware configuration example of a station placement design support device 10 according to the embodiment of the present invention.

FIG. 3 is a diagram illustrating a functional configuration example of the station placement design support device 10 according to the embodiment of the present invention.

FIG. 4 is a flowchart for explaining an example of a processing procedure executed by the station placement design support device 10.

FIG. 5 is a diagram for explaining environment information and base station candidate information.

FIG. 6 is a diagram for explaining an example of a method of extracting some relay station candidates.

### DESCRIPTION OF EMBODIMENTS

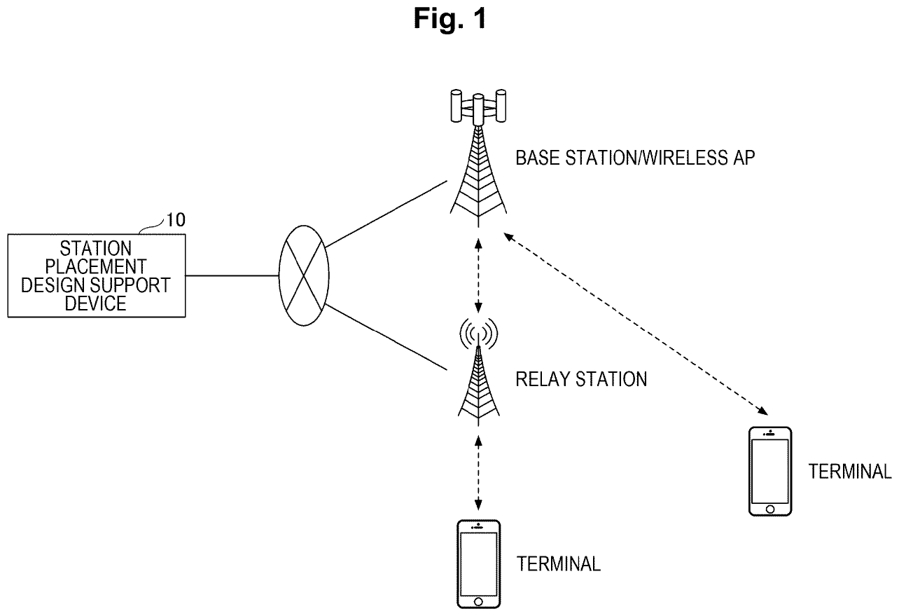

Hereinafter, embodiments of the present invention will be described with reference to the drawings. FIG. 1 is a diagram illustrating a system configuration example according to the embodiment of the present invention. In FIG. 1, a station placement design support device 10 is connected with one or more base stations (a base station in a mobile communication network or a wireless access point (AP) in a wireless LAN or the like), one or more relay stations, and the like scheduled to be arranged in a certain area (which will be hereinafter referred to as a “target area A1”) via a network (wired or wireless (IAB, WiGig, etc.)). A relay station is a communication device that relays wireless communication between a base station and a terminal. Hereinafter, in a case where a base station and a relay station are not distinguished from each other, they are each referred to as a “wireless station”.

Each wireless station is an example of the communication device that provides wireless communication to a terminal using a mobile communication network (such as 5G) or a wireless LAN (such as Wi-Fi (registered trademark) ).

The station placement design support device 10 is one or more computers that calculate an arrangement state (position and direction) of one or more wireless stations. Some or all of the wireless stations may be existing wireless stations, or all of the wireless stations may be new wireless stations. The actual arrangement of the wireless stations may be performed by arrangement by movement of the wireless stations on their own (which may be hereinafter referred to as “automatic arrangement”), or may be performed by arrangement by man power (which will be hereinafter referred to as “manual arrangement”). The automatic arrangement may be realized by controlling a wireless station including moving means such as a drone or an automatic guided vehicle (AGV), through the station placement design support device 10 or the like. For example, the automatic arrangement may be performed in real time according to a change in the distribution of the positions of the terminals or the like. Moreover, the automatic arrangement or the manual arrangement may be performed according to a long-term environmental change that has occurred in a certain period in the past.

In FIG. 1, the station placement design support device 10 is connected with a wireless station via a network because automatic arrangement is assumed. However, in a case where manual arrangement is adopted, the station placement design support device 10 may not be connected with a wireless station via a network.

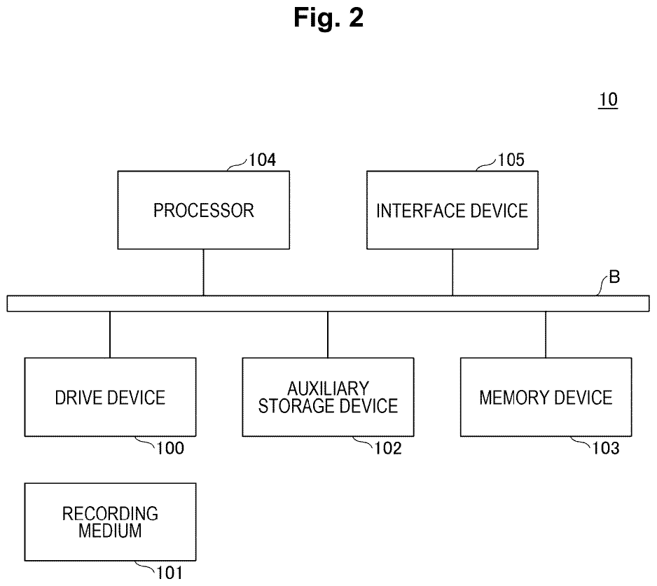

FIG. 2 is a diagram illustrating a hardware configuration example of the station placement design support device 10 according to the embodiment of the present invention. The station placement design support device 10 in FIG. 2 includes a drive device 100, an auxiliary storage device 102, a memory device 103, a processor 104, an interface device 105, and the like, which are connected with one another by a bus B.

A program for implementing processing in the station placement design support device 10 is provided by a recording medium 101 such as a CD-ROM. When the recording medium 101 storing the program is set in the drive device 100, the program is installed from the recording medium 101 to the auxiliary storage device 102 via the drive device 100. However, the program is not necessarily installed from the recording medium 101, and may be downloaded from another computer via a network. The auxiliary storage device 102 stores the installed program and also stores necessary files, data, and the like.

In a case where an instruction to start the program is given, the memory device 103 reads the program from the auxiliary storage device 102 and stores the program. The processor 104 is a CPU or a graphics processing unit (GPU), or includes both a CPU and a GPU. The processor 104 executes a function regarding the station placement design support device 10 according to the program stored in the memory device 103. The interface device 105 is used as an interface for a connection with a network.

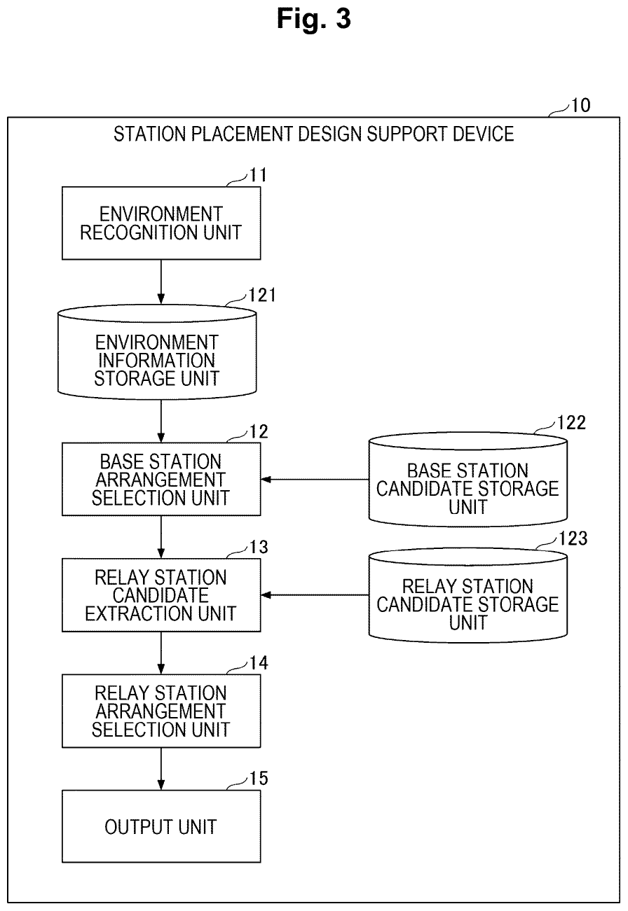

FIG. 3 is a diagram illustrating a functional configuration example of the station placement design support device 10 according to the embodiment of the present invention. In FIG. 3, the station placement design support device 10 includes an environment recognition unit 11, a base station arrangement selection unit 12, a relay station candidate extraction unit 13, a relay station arrangement selection unit 14, and an output unit 15. Each of these units is implemented by processing performed by one or more programs that are installed in the station placement design support device 10 and that cause the processor 104 to execute the units. The station placement design support device 10 also uses an environment information storage unit 121, a base station candidate storage unit 122, and a relay station candidate storage unit 123. Each of these storage units can be implemented by using, for example, the auxiliary storage device 102, a storage device connectable with the station placement design support device 10 via the network or the like.

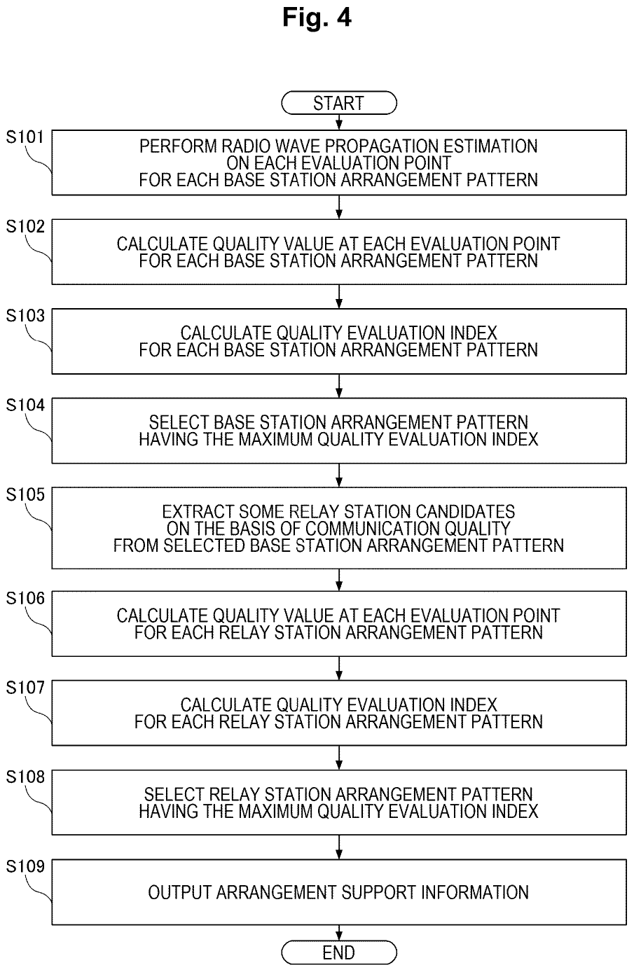

Hereinafter, a processing procedure executed by the station placement design support device 10 will be described. FIG. 4 is a flowchart for explaining an example of the processing procedure executed by the station placement design support device 10.

In steps S101 to S104, the base station arrangement selection unit 12 selects such an arrangement state of base stations where the communication quality of the target area A1 with preset I (I≥1) base stations is maximized.

Specifically, in step S101, the base station arrangement selection unit 12 performs radio wave propagation estimation related to one or more preset points (which will be hereinafter referred to as an “evaluation point ep”) for each of all (a plurality of) base station arrangement patterns in the target area A1. The radio wave propagation estimation is performed on the basis of environment information stored in the environment information storage unit 121, base station candidate information stored in the base station candidate storage unit 122, and the like.

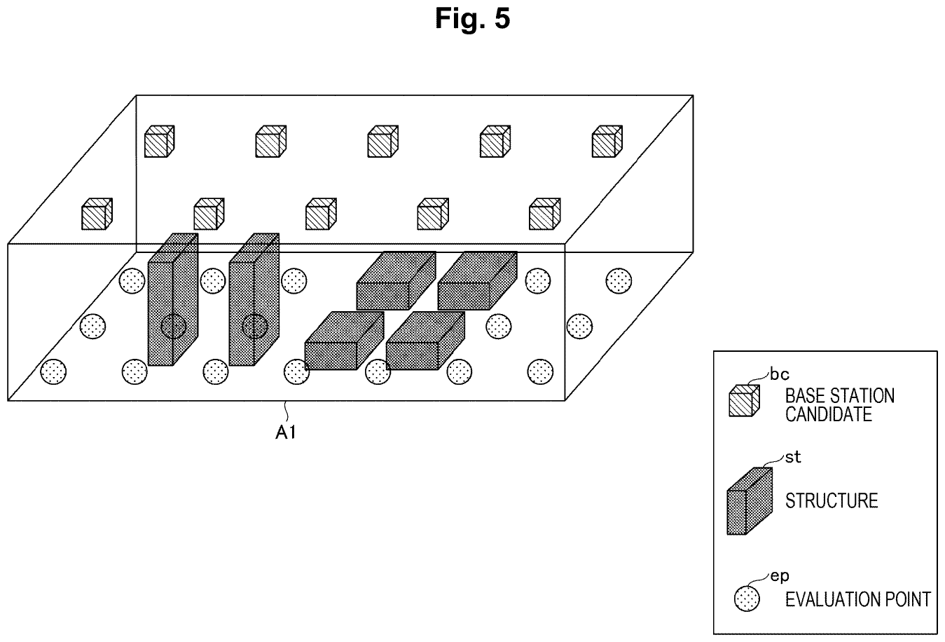

FIG. 5 is a diagram for explaining the environment information and the base station candidate information. FIG. 5 illustrates an example in which the target area A1 has a rectangular parallelepiped shape for convenience, and 10 base station candidates bc are set in the space of the target area A1. In FIG. 5, the arrangement positions and shapes of six structures st that may block radio waves are clearly defined, and 15 evaluation points ep are set.

Here, the range and shape of the target area A1, the position and shape of each structure st, and the like are included in the environment information. For example, the environment information may be generated in advance by the environment recognition unit 11 on the basis of data that is obtained from a camera, a sensor, or the like in advance by the environment recognition unit 11, a design drawing of the target area A1 or the like. Alternatively, the environment information may be input by the user.

On the other hand, the positions of the base station candidates bc and the evaluation points ep are included in the base station candidate information. The base station candidate bc is a candidate for an arrangement position of each base station. That is, all base stations are each allocated to any of the base station candidates bc.

Note that the position information of the base station candidates bc, the structures st, and the evaluation points ep may be three-dimensional coordinate information, or may be two-dimensional coordinate information. Moreover, the size of a geographical range of the target area A1 is not limited. A specific indoor range such as an event venue may be the target area A1, or a wide outdoor region may be the target area A1. In the former case, the structures st are, for example, objects or the like disposed indoors. In the latter case, the structures st are, for example, buildings.

Moreover, the base station arrangement pattern refers to a combination of positions and directions of I base stations. Here, the positions of the I base stations are limited to any of the base station candidates bc. In other words, the base station arrangement pattern refers to an arrangement state of each base station determined by a combination of I base station candidates bc from among all the base station candidates bc, and a direction of each base station in each of the I base station candidates bc.

In this case, a maximum number of base stations that can be arranged in one base station candidate bc is one. Moreover, in the base station arrangement pattern, a difference in the arrangement order of the base stations is not distinguished. Accordingly, if the number of base station candidates bc is J and there are K directions of each base station, a total number of base station arrangement patterns is _{I}C_{J}×K^{I}. Note that the direction of a base station is the orientation of the base station (the direction of the antenna).

The radio wave propagation estimation at each evaluation point ep for each base station arrangement pattern can be realized by performing, based on the position and direction of each base station in each base station arrangement pattern, a radio wave propagation simulation between a base station candidate bc and an evaluation point ep by, for example, ray tracing or the like using 3D map information. By the radio wave propagation estimation related to a certain base station arrangement pattern, the attenuation amount (path loss) of the radio wave from each base station to each evaluation point ep is calculated for a case where each base station is arranged according to the base station arrangement pattern.

Then, the base station arrangement selection unit 12 calculates a value (which will be hereinafter referred to as a “quality value”) of a predetermined index related to the quality of wireless communication for each evaluation point ep on the basis of the result of the radio wave propagation estimation on each evaluation point ep for each base station arrangement pattern (S102). The quality value may be (the maximum value of) reception power or (the maximum value of) a throughput value. The reception power from a certain base station at a certain evaluation point ep can be calculated by subtracting an attenuation amount of the radio wave from the base station to the evaluation point ep from the transmission power from the base station. The throughput value may be obtained by applying the reception power to a table indicating a correspondence relationship between the reception power and the throughput value, or may be obtained by another method using the reception power as an input. Alternatively, actual measurement values may be used as the reception power and the throughput.

Then, the base station arrangement selection unit 12 calculates the value of the quality evaluation index X by a predetermined method for each base station arrangement pattern (S103). Examples of the quality evaluation index X include, for the quality value of each evaluation point ep, an achievement ratio (a ratio of quality values that are equal to or larger than the target value) of a preset target value (target reception power or target throughput value), a minimum quality value (minimum reception power or minimum throughput), and the like. The minimum quality value refers to the minimum value among (the maximum value of) the quality value for each evaluation point ep.

Alternatively, the base station arrangement selection unit 12 may calculate a sight area ratio of each base station arrangement pattern as the value of the quality evaluation index X for each base station arrangement pattern. The sight area ratio of a certain base station arrangement pattern refers to a ratio of an area of a visibility region that can be seen from any base station to the area (e.g., the area of the bottom surface in FIG. 5) of the target area A1 in a case where each base station is arranged according to the base station arrangement pattern. The sight region that can be seen from any base station refers to a set of points where there is no structure st on a straight line from at least one base station. Alternatively, a ratio of the number of evaluation points ep that can be seen from any base station to all the evaluation points ep may be set as the sight area ratio. In a case where the sight area ratio is adopted as the quality evaluation index X, steps S101 and S102 may not be executed.

Then, the base station arrangement selection unit 12 selects the base station arrangement pattern (which will be hereinafter referred to as a “selected base station arrangement pattern”) having the maximum value of the quality evaluation index X (S104). Note that, in a case where the values of the quality evaluation indexes X of a plurality of base station arrangement patterns are the maximum, for example, the base station arrangement selection unit 12 may calculate the values of the plurality of types of quality evaluation indexes X for the base station arrangement pattern and select one base station arrangement pattern having the maximum weighted sum of the quality evaluation indexes X, or may randomly select one base station arrangement pattern.

Then, in steps S105 to S108, in a case where the base stations are arranged according to the selected base station arrangement pattern, the relay station candidate extraction unit 13 and the relay station arrangement selection unit 14 execute processing for selecting an arrangement state that maximizes the communication quality in the target area A1 for K relay stations. K is a preset integer of 1 or more.

Specifically, in step S105, the relay station candidate extraction unit 13 extracts some relay station candidates from among a plurality of positions (which will be hereinafter referred to as “relay station candidates”) set in advance as candidates for an arrangement position of the relay station in the target area A1 on the basis of the selected base station arrangement pattern. That is, the relay station candidates are narrowed down on the basis of the selected base station arrangement pattern.

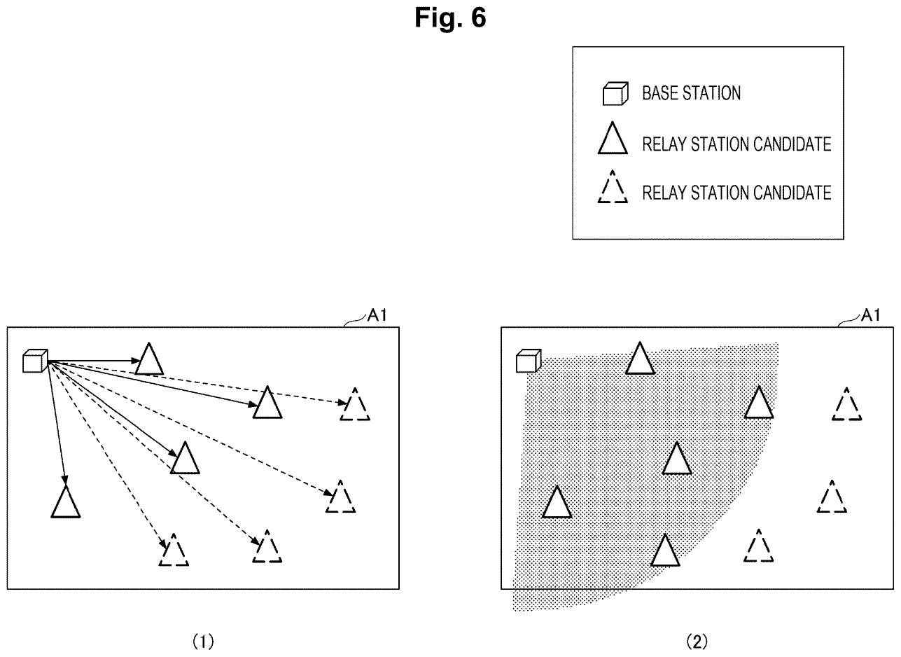

FIG. 6 is a diagram for explaining an example of a method of extracting some relay station candidates. In FIG. 6, two methods are shown, a method shown as (1) (which will be hereinafter referred to as “method (1)”) and a method shown as (2) (which will be hereinafter referred to as “method (2)”). Note that the positions of the relay station candidates illustrated in FIG. 6 are stored in advance in the relay station candidate storage unit 123.

The method (1) is a method of extracting a relay station candidate whose communication quality value (a quality value, throughput, or the like) with any base station is equal to or larger than a predetermined threshold, on the basis of a radio wave propagation simulation result from each base station to each relay station candidate in an arrangement state according to a selected base station arrangement pattern. In (1), each solid line arrow indicates a radio wave between a base station and a relay station candidate whose quality value is equal to or larger than the threshold, and each broken line arrow indicates a radio wave between a base station and a relay station candidate whose quality value is smaller than the threshold. Accordingly, in the case of (1), the relay station candidates that are connected by solid arrows and drawn with solid lines are extracted. In other words, the relay station candidates connected by the dashed arrows and drawn with the dashed lines are excluded. In this case, since a relay station candidate whose quality between a base station and the relay station is equal to or higher than a certain level is extracted, it is possible to avoid deterioration of communication quality due to insufficient quality between the base station and the relay station. Note that, although only one base station is shown in FIG. 6 for convenience, I patterns of quality values that are determined from I base stations are estimated for each relay station candidate. It is sufficient to extract a relay station candidate whose maximum value among the I patterns of quality values is equal to or larger than a threshold.

The method (2) is a method of extracting a relay station candidate whose distance (slant distance) from any base station in an arrangement state according to a selected base station arrangement pattern is equal to or shorter than a predetermined threshold. A fan-shaped area in (2) indicates a partial region in a circle centered on the base station and having a radius of the threshold. In the case of (2), a relay station candidate included in the region and drawn with solid lines is extracted. In other words, relay station candidates that are not included in the region and are drawn with broken lines are excluded. According to the method (2), it is possible to easily calculate a relay station candidate conforming to the method (1). The method (2) is particularly effective in a case where a relatively low frequency band is used as a use frequency between a base station and a relay station. In a case where a high frequency band (28 GHz band or the like) is adopted, it is desirable to have an environment with less (negligible) shielding.

The relay station candidate extracted in step S105 will be hereinafter referred to as an “extracted candidate”.

Then, the relay station arrangement selection unit 14 calculates a quality value related to wireless communication at each evaluation point ep for each relay station arrangement pattern (S106). The relay station arrangement pattern refers to combinations of positions and directions of K relay stations. Here, the positions of the K relay stations are limited to any of the extracted candidates. In other words, the relay station arrangement pattern refers to an arrangement state of each relay station determined by a combination of K extraction candidates from among all the extracted candidates and a direction of each relay station in each of the K extracted candidates. At this time, the maximum number of relay stations that can be arranged in one extracted candidate is one. Moreover, in the relay station arrangement pattern, a difference in the arrangement order of the relay stations is not distinguished.

Moreover, the quality value related to wireless communication at each evaluation point ep is as described in step S102. Here, in step S106, for one relay station arrangement pattern, a quality value related to each relay station and a quality value related to each base station according to the selected base station arrangement pattern are calculated for each evaluation point ep. The maximum value among the quality values calculated for a certain evaluation point ep regarding a certain relay station arrangement pattern is the quality value at the evaluation point ep related to the relay station arrangement pattern. In this case, since the quality value can be evaluated in consideration of a state close to the actual connection state, it is possible to select the relay station arrangement pattern using the quality value based on higher quality estimation accuracy.

Alternatively, the relay station arrangement selection unit 14 may calculate the quality value for each relay station arrangement pattern for an evaluation point ep whose quality value related to the base station according to the selected base station arrangement pattern is relatively small (e.g., equal to or smaller than the threshold). In this case, the quality value calculated for a certain evaluation point ep regarding a certain relay station arrangement pattern may be the maximum value among the quality values related to the relay stations according to the certain relay station arrangement pattern. That is, the quality value related to the base station according to the selected base station arrangement pattern may not be considered. This is because the quality value related to the base station according to the selected base station arrangement pattern is considered in narrowing down the evaluation points ep. In this case, the calculation amount can be reduced as compared with a case where the evaluation points ep are not narrowed down.

Then, the relay station arrangement selection unit 14 calculates the value of the quality evaluation index X for each relay station arrangement pattern by the method described in step S103 on the basis of the quality value calculated for each evaluation point ep in step S106 (S107).

Then, the relay station arrangement selection unit 14 selects a relay station arrangement pattern (which will be hereinafter referred to as a “selected relay station arrangement pattern”) having the maximum value of the quality evaluation index X (S108). Note that, in a case where the values of the quality evaluation indexes X of a plurality of relay station arrangement patterns are the maximum, one relay station arrangement pattern may be selected in step S104 in a manner similar to that of a case where the values of the quality evaluation indexes X of a plurality of base station arrangement patterns are the maximum.

Then, the output unit 15 outputs information (which will be hereinafter referred to as “arrangement support information”) for supporting the arrangement of the wireless stations (S109). Specifically, the output unit 15 outputs the arrangement support information regarding the selected base station arrangement pattern and the selected relay station arrangement pattern.

For example, in a case where the automatic arrangement is adopted, the arrangement support information may be a control signal indicating an arrangement state (indicating an instruction of movement to the arrangement state) with respect to the wireless station. That is, the output unit 15 may output a control signal indicating movement to the arrangement state according to the selected base station arrangement pattern to each base station, and output a control signal indicating movement to the arrangement state according to the selected relay station arrangement pattern to each relay station.

Alternatively, the arrangement support information may be a value of the quality evaluation index X of the selected base station arrangement pattern together with the selected base station arrangement pattern and the selected relay station arrangement pattern. In this case, the output unit 15 may output the arrangement support information to a display device, the auxiliary storage device 102, or the like so that the user can visually recognize the arrangement support information. In this case, the user may arrange the wireless stations by automatic arrangement or manual movement on the basis of the outputted information.

Note that, although an example has been described in which the base station arrangement selection unit 12 selects one base station arrangement pattern in step S104 and the relay station arrangement selection unit 14 selects one relay station arrangement pattern in step S108 in the above description, a plurality of base station arrangement patterns or a plurality of relay station arrangement patterns may be each selected.

For example, in step S104, the base station arrangement selection unit 12 selects, as selected base station arrangement patterns, base station arrangement patterns whose values of the quality evaluation indexes X are in the top a. Steps S105 to S108 are executed for each of the a selected base station arrangement patterns. At this time, in step S108, the relay station arrangement selection unit 14 selects, as selected relay station arrangement patterns, relay station arrangement patterns whose quality evaluation indexes X are in the top β. As a result, α×β arrangement patterns are obtained for the base station and the relay station.

In this case, the output unit 15 may output arrangement patterns whose values of the quality evaluation indexes X calculated regarding the relay station arrangement patterns are in the top γ among the α×β arrangement patterns together with the values. The user may select any arrangement pattern on the basis of the outputted information, and arrange the wireless stations by automatic arrangement or manual movement according to the selected arrangement pattern.

Note that, although an example in which the station placement design support device 10 executes the processing procedure in FIG. 4 has been explained in the above description, any wireless station may execute the processing procedure in FIG. 4.

As described above, according to the present embodiment, a base station arrangement pattern that maximizes the value of the index of communication quality of the target area A1 is selected from among all the base station arrangement patterns, and then the relay station arrangement pattern is selected. Accordingly, the position and direction of each base station and each relay station can be calculated at high speed without estimating the quality for all combinations of all the base station arrangement patterns and all the relay station arrangement patterns. Moreover, the number of terminals connected via a relay station can be reduced as much as possible, and improvement in overall communication quality (improvement in network utilization efficiency or reduction in communication delay time) can be expected. As a result, it is possible to select an arrangement state of a base station and a relay station at high speed while considering communication quality.

Note that, in the present embodiment, the base station arrangement selection unit 12 is an example of a first selection unit. The relay station candidate extraction unit 13 is an example of an extraction unit. The relay station arrangement selection unit 14 is an example of a second selection unit. The base station arrangement pattern is an example of a first pattern. The selected base station arrangement pattern is an example of a second pattern. The relay station arrangement pattern is an example of a third pattern. The selected relay station arrangement pattern is an example of a fourth pattern.

Although an embodiment of the present invention has been described in detail above, the present invention is not limited to such a specific embodiment, and various modifications and changes can be made within the scope of the gist of the present invention disclosed in the claims.

### REFERENCE SIGNS LIST

10 Station placement design support device
11 Environment recognition unit
12 Base station arrangement selection unit
13 Relay station candidate extraction unit
14 Relay station arrangement selection unit
15 Output unit
100 Drive device
101 Recording medium
102 Auxiliary storage device
103 Memory device
104 Processor
105 Interface device
121 Environment information storage unit
122 Base station candidate storage unit
123 Relay station candidate storage unit
B Bus

1. A radio zone design support apparatus comprising:
circuitry configured to:
select one or more of a plurality of first patterns as one or more second patterns based on a first value of an index related to predetermined communication quality that is different for in of each of the plurality of first patterns in a predetermined area, each of the plurality of first patterns being related to an arrangement state of one or more base stations;
extract one or more candidates from among candidates for an arrangement position of one or more relay stations, for each of the second patterns; and
select one or more of a plurality of third patterns as one or more fourth patterns based on a second value of an index related to predetermined communication quality that is different for of each of the plurality of third patterns in the predetermined area, each of the plurality of third patterns being related to an arrangement state of the one or more relay stations with respect to the one or more candidates extracted for each of the second patterns.

2. The radio zone design support apparatus according to claim 1, wherein for a case where the one or more base stations are arranged according to the second patterns, the circuitry is configured to:
calculate a third value of an index related to the communication quality of each of the candidates, and
extract the one or more candidates based on the third value.

3. The radio zone design support apparatus according to claim 1, wherein for a case where the one or more base stations are arranged according to the second patterns, the circuitry is configured to extract the one or more candidates based on of a distance from a given base station of each of the candidates.

4. The radio zone design support apparatus according to claim 1, wherein the circuitry is configured to:
calculate, for a plurality of locations, values of indexes related to communication quality with a given base station and a given relay station according to each of the third patterns, and
select the fourth patterns based on the values of the indexes.

5. The radio zone design support apparatus according to claim 1, wherein among a plurality of locations, for one or more locations where one or more of values of indexes are less than a threshold when the base stations are arranged according to the second patterns, the circuitry is configured to:
calculate second values of indexes related to the communication quality with the one or more relay stations according to each of the third patterns, and
select the fourth patterns based on the second values.

6. A radio zone design support method executed by a computer, comprising:
selecting one or more of a plurality of first patterns as one or more second patterns based on a value of an index related to predetermined communication quality that is different for in each of the plurality of first patterns in a predetermined area, each of the plurality of first patterns being related to an arrangement state of one or more base stations;
extracting one or more candidates from among candidates for an arrangement position of one or more relay stations, for each of the second patterns; and
a selecting one or more of a plurality of third patterns as one or more fourth patterns based on second value of an index related to predetermined communication quality that is different for each of the plurality of third patterns in the predetermined area, each of the plurality of third patterns being related to an arrangement state of the one or more relay stations with respect to the one or more candidates extracted for each of the second patterns.

7. A non-transitory computer readable storage medium storing a program configured for causing a computer to execute a method, the method comprising:
selecting one or more of a plurality of first patterns as one or more second patterns based on first value of an index related to predetermined communication quality that is different for each of the plurality of first patterns in a predetermined area, each of the plurality of first patterns being related to an arrangement state of one or more base stations;
extracting one or more candidates from among candidates for an arrangement position of one or more relay stations, for each of the second patterns; and
selecting one or more of a plurality of third patterns as one or more fourth patterns based on a value of an index related to predetermined communication quality that is different for each of the plurality of third patterns in the predetermined area, each of the plurality of third patterns being related to an arrangement state of the one or more relay stations with respect to the one or more candidates extracted for each of the second patterns.
